(19) United States
(12) Patent Application Publication
(10) Pub. No.: US 2020/0123311 A1
(43) Pub. Date: Apr. 23, 2020

(54) EPOXY-RESIN MODIFIED COMPOSITION USED FOR COATING OR SEALING

(71) Applicant: SIKA TECHNOLOGY AG, Baar (CH)

(72) Inventors: David TEICHERT, Kornwestheim (DE); Lars CONRAD, Bietigheim-Bissingen (DE); Jochen GRÖTZINGER, Schwäbisch Gmünd (DE)

(73) Assignee: SIKA TECHNOLOGY AG, Baar (CH)

(21) Appl. No.: 16/493,451

(22) PCT Filed: Mar. 8, 2018
(86) PCT No.: PCT/EP2018/055831

§ 371 Date: Sep. 12, 2019

(30) Foreign Application Priority Data
Mar. 13, 2017 (EP) 17160580.1

(51) Int. Cl. C08G 59/50; C04B 26/14; C04B 14/06; C04B 28/04; C09D 163/00

(52) U.S. Cl. CPC C08G 59/502; C04B 26/14; C04B 14/06; C04B 2111/00482; C08G 59/5026; C09D 163/00; C04B 28/04

(57) ABSTRACT

A multicomponent composition which is especially suitable for a floor coating. The composition simultaneously allows an esthetically pleasing appearance (visual appearance, surface characteristics), good processibility and leveling, high gloss and a high proportion of environmentally friendly components.

### TECHNICAL FIELD

The invention relates to a multicomponent composition, to a process for producing a coating with the multicomponent composition and to the use of the multicomponent composition as mortar, seal or coating.

### PRIOR ART

The profile of requirements for floor coating systems is varied in some cases. Desirable properties for floor coatings may be, for example, an esthetically appealing appearance and high mechanical strength. Further demands are, for example, good workability and leveling, high gloss and the use of environmentally friendly components.

Organic or organic-inorganic hybrid systems are in common practical use nowadays for floor coatings. Examples are solvent-free epoxy resin reaction coatings, aqueous epoxy resin coatings, polymer-modified cementitious systems (PCC) such as epoxy resin-modified cementitious systems (ECC) or polyurethane-modified cementitious systems.

The combination of different properties, some of which are at odds in terms of material demands, in a floor coating system is frequently difficult. While standard systems, for example, have good properties with regard to some demands, the properties of the system are frequently unsatisfactory in other respects.

Water-based epoxy resin coatings have relatively low mechanical and chemical stability.

Epoxy resin-modified cementitious systems often have a dull matt appearance, and gloss is not variably adjustable. Typical epoxy resin-modified cementitious systems have a relatively low organic binder content of not more than 5% by weight.

WO2009150212 discloses three-component epoxy resin-modified cementitious systems (ECC) comprising aqueous curing compositions, which can especially be used as coating. However, these coatings have low gloss.

### SUMMARY OF THE INVENTION

The object of the invention was therefore that of providing a composition with which floor coatings having a balanced profile of properties can be produced. More particularly, the intention is to provide a floor coating that simultaneously has an esthetically pleasing appearance (visual appearance, surface characteristics), good processibility and leveling, high gloss and a high proportion of environmentally friendly components. The term “environmentally friendly components” is especially understood to mean additions that are not among the “organic components OA” described below.

The object was surprisingly achieved by a multicomponent composition described hereinafter. The multicomponent composition especially includes a small amount of organic components OA, where the organic components OA are epoxy resins, reactive diluents, amine compounds PA and compounds VB.

The invention therefore relates to a multicomponent composition comprising
A) a binder component (A) comprising at least one epoxy resin,
B) a curing component (B) comprising at least one amine compound PA, and
C) a solid component (C) comprising at least one inorganic filler, characterized in that
the multicomponent composition contains 3-15% by weight of water, based on the total weight of the multicomponent composition,
and in that the multicomponent composition further comprises a compound VB of the formula (I) or (II)

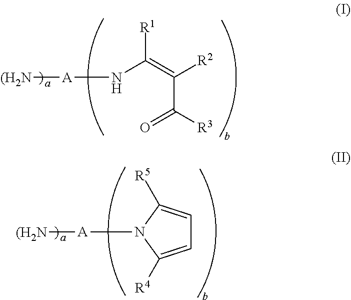

where

either
R¹ and R³ are each independently an alkyl, cycloalkyl, aryl or arylalkyl group which has 1 to 12 carbon atoms and optionally has ether groups or halogen atoms, and
R² is a hydrogen atom or an alkyl, cycloalkyl, aryl or arylalkyl group having 1 to 12 carbon atoms,

or
R² and R¹ together are a divalent hydrocarbyl radical which is part of an optionally substituted carbocyclic ring having 5 to 8, preferably 5 or 6, carbon atoms and R³ is an alkyl, cycloalkyl, aryl or arylalkyl group which has 1 to 12 carbon atoms and optionally has ether groups or halogen atoms;

or
R² and R³ together are a divalent hydrocarbyl radical which is part of an optionally substituted carbocyclic ring having 5 to 8, preferably 5 or 6, carbon atoms and R¹ is an alkyl, cycloalkyl, aryl or arylalkyl group which has 1 to 12 carbon atoms and optionally has ether groups or halogen atoms;
R⁴ and R⁵ are each independently an alkyl, cycloalkyl, aryl or arylalkyl group which has 1 to 12 carbon atoms and optionally has ether groups or halogen atoms;
A is an (a+b)-valent radical of a polyamine-polyepoxide adduct after removal of (a+b) primary amino groups;
a is an integer from 0 to 4; and
b is an integer from 1 to 4;
with the provisos that the sum total of a and b is an integer from 1 to 4, and that the parent polyepoxide of the polyamine-polyepoxide adduct is a polyepoxide E, especially a diepoxide E1, and has an epoxy equivalent weight (EEW) of 65 to 500 g/eq,
   and where the weight ratio of amine compound PA to compound VB is 4-20,
   and where the proportion by weight of the solid component (C) is 25-62% by weight, based on the total weight of the multicomponent composition.

The term “polyamine” in the present document refers to compounds having at least two primary or secondary amino groups.

In the present document, a “primary” amino group refers to an NH₂ group bonded to one organic radical, and a “secondary” amino group refers to an NH group bonded to two organic radicals which may also together be part of a ring. In the present document, “molecular weight” is understood to mean the molar mass (in grams per mole) of a molecule. “Average molecular weight” refers to the number-average molecular weight Mₙ of a polydisperse mixture of oligomeric or polymeric molecules, which is typically determined by means of GPC against polystyrene as standard.

The term “polyepoxide” in the present document refers to compounds having at least two epoxy groups. “Diepoxide” refers to compounds having two epoxy groups.

“Epoxide group” or “epoxy group” in the present document refers to the structural element

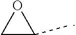

The acyl-enamino groups of the formula (i) are in an equilibrium with the tautomeric isomers of the formula (ii) and of the formula (iii). Every mention of the acyl-enamino groups of the formula (i) likewise means the tautomers of the formula (ii) and of the formula (iii), even though this is not mentioned explicitly in the particular case.

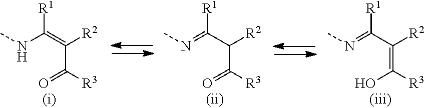

In this document, the dotted lines in the formulae each represent the bond between a substituent and the corresponding molecule residue.
Preferably, R¹ and R³ are each a methyl group.
Preferably, R² is a hydrogen atom.
Preferably, R⁴ and R⁵ are each a methyl group.
Preferably, a is 0.
Preferably, b is 1.

The polyamine-polyepoxide adduct from which A in the formulae (I) and (II) derives is free of epoxy groups and has (a+b) primary amino groups. It is an addition product of at least one polyamine A1 and optionally further amines, preferably at least one further amine A2, with at least one polyepoxide E, especially a diepoxide E1. The polyepoxide E has an epoxy equivalent weight of 65 to 500 g/eq. The polyamine A1is preferably a polyamine having two primary amino groups. The amine A2 is preferably an amine having only one primary amino group. The polyepoxide E is preferably a diepoxide E1, more preferably a liquid diglycidyl ether of bisphenols, especially of bisphenol A.

The abbreviation “EEW” in the present document stands for “epoxy equivalent weight”.

“Glycidyl ether” in the present document refers to an ether of 2,3-epoxy-1-propanol (glycidol).

A compound VB of the formula (I) is preferably a compound VB of the formula (I a) or (I b). A compound VB of the formula (II) is preferably a compound VB of the formula (II a) or (II b).

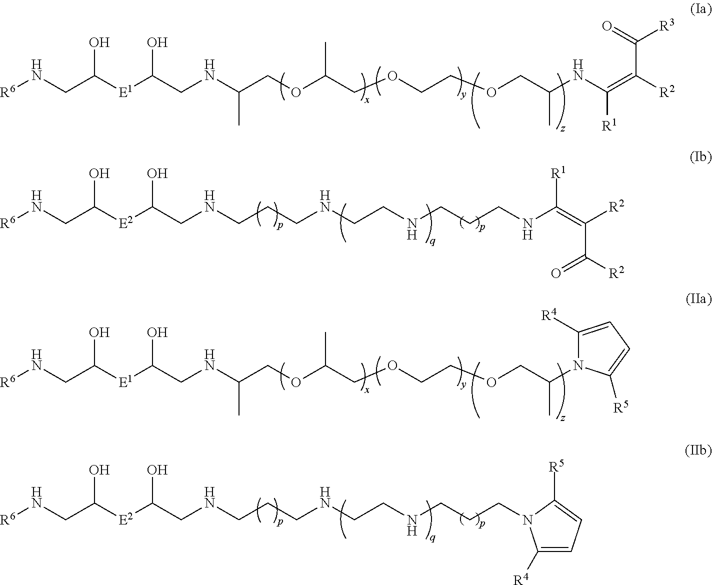

In the formulae (I a), (I b), (II a) and (II b), R¹, R², R³, R⁴ and R⁵ have the definitions already given, and

R⁶ is an alkyl or cycloalkyl or arylalkyl group optionally having ether or secondary amino groups;

E¹ and E² are each independently the residue of a diepoxide E1 having an EEW of 65 to 500 g/eq after removal of two epoxy groups;
x is an integer from 0 to 50;
y is an integer from 0 to 100, preferably 10 to 50;
z is an integer from 1 to 50;
(x+z) is an integer from 1 to 100, preferably 1 to 10;
p is 0 or 1; and
q is 0, 1, 2 or 3.

Preferably, R⁶ in the formulae (I a), (II a), (I b) and (II b) is an alkyl or cycloalkyl or arylalkyl group having at least 4 carbon atoms, especially having 4 to 18 carbon atoms, and optionally having ether or secondary amino groups.

Preferably, the diepoxide E1 is selected from the group consisting of a bisphenol A diglycidyl ether, bisphenol F diglycidyl ether and bisphenol A/F diglycidyl ether having an epoxy equivalent weight of 156 to 250 g/eq, N,N-diglycidylaniline and a polyglycol diglycidyl ether having an epoxy equivalent weight of 170 to 340 g/eq.

More preferably, the diepoxide E1 is a bisphenol A diglycidyl ether, bisphenol F diglycidyl ether and bisphenol A/F diglycidyl ether.

Thus, E¹ in the formulae (I a) and (II a) and E² in the formulae (I b) and (II b) are preferably in each case independently the residue of a diepoxide E1 selected from the group consisting of a bisphenol A diglycidyl ether, bisphenol F diglycidyl ether and bisphenol A/F diglycidyl ether having an epoxy equivalent weight of 156 to 250 g/eq, N,N-diglycidylaniline and a polyglycol diglycidyl ether having an epoxy equivalent weight of 170 to 340 g/eq, especially a bisphenol A diglycidyl ether, bisphenol F diglycidyl ether and bisphenol A/F diglycidyl ether having an epoxy equivalent weight of 156 to 250 g/eq, after removal of two epoxy groups.

Preferably, the compound VB of the formula (I) or (II) is present in the curing component (B).

Preferred embodiments of the composition are given in the dependent claims. The invention is elucidated in detail hereinafter.

### Way of Executing the Invention

Compound names that begin with “poly” refer to substances that, in a formal sense, contain two or more of the functional groups that occur in their names per molecule. The compound may be monomeric, oligomeric or polymeric. A polyamine is, for example, a compound having two or more amino groups. A polyepoxide is a compound having two or more epoxy groups.

Epoxy resins are polyepoxides, i.e. compounds having two or more epoxy groups. Epoxy resins are preferably oligomeric or polymeric compounds.

Epoxy resins are sometimes also used in conjunction with what are called reactive diluents. Reactive diluents are mono- or polyepoxides. The reactive diluents have a lower viscosity than the epoxy resin used and serve to reduce the viscosity of the epoxy resin used. The optional reactive diluent is likewise incorporated into the organic binder matrix and is therefore counted here among the epoxy resins for the determination of the organic binder content.

The epoxy equivalent weight (EEW) can be determined according to DIN 53188 and is reported in g/eq. The NH equivalent weight can be determined according to DIN 16945 and is reported in g/eq. The stoichiometric ratio of epoxy functionality to amine functionality is the quotient of epoxy equivalent weight to NH equivalent weight and is frequently reported in %. The NH equivalent weight is based here on the active NH hydrogens. A primary amine, for example, has two active NH hydrogens.

The composition of the invention is a multicomponent composition, i.e. the composition comprises multiple, especially three or more, individual components that are only mixed together on use. The components are stored separately before use in order to avoid spontaneous reaction. For use, the components are mixed with one another. After the mixing, inorganic hydration and organic crosslinking reactions may commence, which ultimately lead to curing of the mixture.

The composition of the invention comprises a binder component (A), a curing component (B) and a solid component (C). The composition may be a three-component composition that consists solely of these three components. The composition may, however, if required, also include one or more further additional components. If, for example, the multicomponent composition of the invention, in the preferred embodiment, comprises pigments as colorants, these may be present in at least one of the three components (A), (B) and (C) mentioned and/or in an additional pigment component (D).

It is clear that the proportion of a particular ingredient in the mixture of the components depends on the proportion of this ingredient in the component in question and the mixing ratio of the components. Proportions or ratios of particular ingredients that are specified here, unless stated otherwise, relate to the appropriate or suitable proportions by weight or weight ratios of the ingredients in the mixture of the components of the multicomponent composition. This is obtained, for example, by mixing the components in suitable mixing ratios according to use instructions.

The binder component (A) comprises at least one epoxy resin and optionally a reactive diluent. The binder component (A) is preferably a liquid component. It may be viscous, but is generally pourable.

The binder component (A) comprises at least one epoxy resin. It is possible to use one epoxy resin or a mixture of two or more epoxy resins. Epoxy resins used may be any of the epoxy resins that are customary in epoxy chemistry. Epoxy resins can be prepared, for example, in a known manner from the oxidation of the corresponding olefins or from the reaction of epichlorohydrin with the corresponding polyols or polyphenols.

Epoxy resins can be subdivided into liquid epoxy resins and solid epoxy resins. The epoxy resin may have, for example, an epoxy equivalent weight of 156 to 500 g/eq. The epoxy resin is preferably a diepoxide.

In one embodiment, the epoxy resin may be an aromatic epoxy resin. Suitable examples for this purpose are liquid epoxy resins of the formula (III)

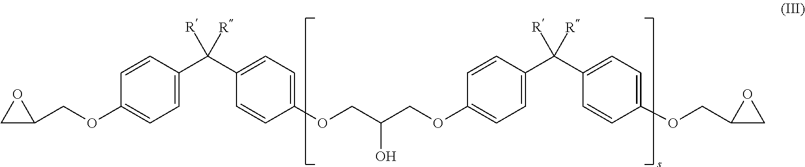

where R′ and R″ are each independently a hydrogen atom or a methyl group, and s has an average value of 0 to less than 2 and preferably 0 to 1. Preference is given to those liquid resins of the formula (III) in which the index s has an average value of less than 0.2.

The epoxy resins of the formula (III) are diglycidyl ethers of bisphenol A, bisphenol F and bisphenol A/F, where A stands for acetone and F for formaldehyde, which serve as reactants for preparation of these bisphenols. Such liquid epoxy resins are commercially available, for example, under the following names: Araldite® from Huntsman, D.E.R.® from Dow, Epikote® from Momentive, Epalloy® from CVC, Chem Res® from Cognis or Beckopox® from Cytec.

Further suitable aromatic epoxy resins are the glycidylization products of:
dihydroxybenzene derivatives such as resorcinol, hydroquinone and catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether, bis(4-hydroxyphenyl) sulfone;
condensation products of phenols with formaldehyde that are obtained under acidic conditions, such as phenol novolaks or cresol novolaks;
aromatic amines such as aniline, toluidine, 4-am inophenol, 4,4′-methylenediphenyldiamine (MDA), 4,4′-methylenediphenyldi(N-methyl)amine, 4,4′[1,4-phenylenebis(1-methylethylidene)]bisaniline (bisaniline P),[1,3-phenylenebis(1-methylethylidene)]bisaniline (bisaniline M).

In a further embodiment, the epoxy resin may be an aliphatic or cycloaliphatic epoxy resin, for example
diglycidyl ether;
a glycidyl ether of a saturated or unsaturated, branched or unbranched, cyclic or open-chain C₂ to C₃₀ diol, for example ethylene glycol, propylene glycol, butylene glycol, hexanediol, octanediol, a polypropylene glycol, dimethylolcyclohexane, neopentyl glycol;
a glycidyl ether of a tri- or tetrafunctional, saturated or unsaturated, branched or unbranched, cyclic or open-chain polyol such as castor oil, trimethylolpropane, trimethylolethane, pentaerythritol, sorbitol or glycerol, and alkoxylated glycerol or alkoxylated trimethylolpropane;
a hydrogenated liquid bisphenol A, F or A/F resin, or the glycidylization products of hydrogenated bisphenol A, F or A/F;
an N-glycidyl derivative of amides or heterocyclic nitrogen bases, such as triglycidyl cyanurate and triglycidyl isocyanurate, and reaction products of epichlorohydrin and hydantoin.

Further examples of usable epoxy resins are epoxy resins that have been prepared from the oxidation of olefins, for example from the oxidation of vinylcyclohexene, dicyclopentadiene, cyclohexadiene, cyclododecadiene, cyclododecatriene, isoprene, hexa-1,5-diene, butadiene, polybutadiene or divinylbenzene.

Further examples of usable epoxy resins are a solid bisphenol A, F or A/F resin that are formed in the same way as the aforementioned liquid epoxy resins of the formula (III) except that the index s has a value of 2 to 12. Further examples are all aforementioned epoxy resins that have been hydrophilically modified by reaction with at least one polyoxyalkylenepolyol.

Preferred epoxy resins are solid or liquid bisphenol A, F or A/F resins as commercially available, for example, from Dow, Huntsman and Momentive. Epoxy resins used are more preferably diepoxides of a bisphenol A diglycidyl ether, bisphenol F diglycidyl ether and bisphenol A/F diglycidyl ether, especially those having an epoxy equivalent weight of 156 to 250 g/eq, for example the commercial products Araldite® GY 250, Araldite® PY 304, Araldite® GY 282 (from Huntsman); D.E.R.® 331, D.E.R.® 330 (from Dow); Epikote® 828, Epikote® 862 (from Momentive), and N,N-diglycidylaniline and a polyglycol diglycidyl ether, preferably having an epoxy equivalent weight of 170 to 340 g/eq., for example the commercial products D.E.R.® 732 and D.E.R.® 736 (from Dow).

It may be advantageous that the binder component (A) contains at least one reactive diluent. As stated, this is counted as part of the epoxy resin for the organic binder content. It is possible to use one or more reactive diluents. Suitable reactive diluents are mono- and polyepoxides. The addition of a reactive diluent to the epoxy resin brings about a reduction in viscosity and, in the cured state of the epoxy resin composition, a reduction in glass transition temperature and the mechanical values.

Examples of reactive diluents are glycidyl ethers of mono- or polyhydric phenols and aliphatic or cycloaliphatic alcohols, such as, in particular, the polyglycidyl ethers of di- or polyols that have already been mentioned as aliphatic or cycloaliphatic epoxy resins, and also, in particular, phenyl glycidyl ether, cresyl glycidyl ether, p-n-butylphenyl glycidyl ether, p-tert-butylphenyl glycidyl ether, nonylphenyl glycidyl ether, allyl glycidyl ether, butyl glycidyl ether, hexyl glycidyl ether, 2-ethylhexyl glycidyl ether, and glycidyl ethers of natural alcohols, for example C₈- to C₁₀-alkyl glycidyl ethers, C₁₂- to C₁₄-alkyl glycidyl ethers or C₁₃- to C₁₅-alkyl glycidyl ethers, commercially available as Erisys® GE-7, Erisys® GE-8 (from CVC) or as Epilox® P 13-19 (from Leuna).

The binder component (A) may optionally contain one or more further additives. Suitable additives are elucidated further down.

Preferably, the multicomponent composition, based on the total weight of the multicomponent composition, contains 25-40% by weight, especially 25-35% by weight, of binder component (A).

The curing component (B) comprises at least one amine compound PA. The curing component (B) is preferably a liquid component. It may be viscous, but is generally pourable.

The amine compound PA may be any amine compound which is typically used in industry as hardener for epoxy resins. Such amine curing agents are commercially available. It is possible to use one amine compound or two or more amine compounds. Suitable amine compounds in principle are monoamines if the amine is a primary amine, but compounds having at least two amino groups are more preferable. The amino groups may be primary and/or secondary amino groups. It is optionally also possible to use blocked amine compounds.

Preferably, the at least one amine compound PA is selected from the group consisting of polyamine A4, polyaminoamide, polyamine-polyepoxide adduct AD and polyaminoamide-polyepoxide adduct or a mixture of at least two of these compounds which each especially contain at least two amino groups, where the amino groups may optionally be in blocked form, but this is generally not preferred.

Preferably, the polyamine-polyepoxide adduct AD is an adduct of at least one polyamine A3 having at least two amino groups in the form of primary or secondary amino groups and at least one polyepoxide E having an epoxy equivalent weight (EEW) of 65 to 500 g/eq, where the adduct has terminal primary and/or secondary amino groups, and where the polyamine A3 is selected from the group consisting of firstly polyoxyalkylenediamines having a molecular weight of not more than 1000 g/mol, and secondly isophoronediamine (IPDA), 2,2,4- and 2,4,4-trimethylhexamethylenediamine (TMD), xylylene-1,3-diamine (meta-xylylenediamine or MXDA), 2-butyl-2-ethylpentane-1,5-diamine (C11 neodiamine), N-ethylpropane-1,3-diamine and N-cyclohexylpropane-1,3-diamine.

For preparation of a suitable adduct AD, polyepoxides E that are suitable and also preferred are those as already described for preparation of a compound VB of the formula (I) or (II), especially the diepoxides E1 mentioned. A particularly suitable adduct AD is the adduct of two moles of polyamine A3 having two amino groups in the form of primary or secondary amino groups and one mole of diepoxide E1.

Preferably, the polyamine A4 is selected from the group consisting of isophoronediamine (IPDA), bis(4-aminocyclohexyl)methane (H12-MDA), bis(4-amino-3-methylcyclohexyl)methane, 2,2,4- and 2,4,4-trimethylhexamethylenediamine (TMD), xylylene-1,3-diamine (meta-xylylenediamine or MXDA) and 2-butyl-2-ethylpentane-1,5-diamine (C11 neodiamine).

Polyaminoamide refers to the reaction product of a mono- or polybasic carboxylic acid, or esters or anhydrides thereof, and an aliphatic, cycloaliphatic or aromatic polyamine, where the polyamine is used in a stoichiometric excess. The polybasic carboxylic acid is typically what is called a dimer fatty acid, and the polyamine used is typically a polyalkyleneamine, for example TETA. Commercially available polyaminoamindes are, for example, Versamid® 100, 125, 140 and 150 (from Cognis), Aradur® 223, 250 and 848 (from Huntsman), Euretek® 3607, Euretek® 530 (from Huntsman), Beckopox® EH 651, EH 654, EH 655, EH 661 and EH 663 (from Cytec).

It is particularly preferable that the at least one amine compound PA is a polyamine A4 or a mixture of polyamine A4 and polyamine-polyepoxide adduct AD.

Preferably, the weight ratio of polyamine A4 to polyamine-polyepoxide adduct AD is 5-50, especially 10-45, preferably 15-25.

In the multicomponent composition, the weight ratio of amine compound PA to compound VB is 4-20. Preferably, the weight ratio of amine compound PA to compound VB is 6-16, especially 6-15, preferably 7-10.

It is apparent from comparative example Ref2 (without compound VB) that particularly the visual appearance and leveling attain inadequate values in its absence. The values for gloss are also significantly poorer than, by way of example, for example Ex1 or Ex2.

Moreover, example Ex3 shows that higher values for the weight ratio of amine compound PA to compound VB in compositions without hydraulic inorganic binder, especially cement, lead to a reduction in gloss. Moreover, it is clear in example Ex8 that gloss values improve in compositions including a hydraulic inorganic binder, especially cement, but the values for visual appearance and processibility worsen.

Moreover, examples Ex4 and Ex7 show that lower values for the weight ratio of amine compound PA to compound VB lead to a reduction in visual appearance, leveling and processibility. Moreover, there are many pinholes.

The curing component (B) may optionally contain one or more further additives. Suitable additives are elucidated further down.

The solid component (C) comprises at least one inorganic filler. Component (C) is a solid component and is preferably pulverulent.

The inorganic fillers are preferably selected from the list consisting of silicon compounds such as silicon dioxide, silicates and precipitated and fumed silicas; metal oxides such as titanium dioxide, iron oxide, alumina, zinc oxide and magnesium oxide; metal carbonates such as calcium carbonate or dolomite; metal sulfates such as calcium sulfate (gypsum) and barium sulfate; metal hydroxides such as aluminum hydroxide, nitrides or carbides, clay minerals such as kaolin, glasses and ceramic materials.

The silicon dioxide may, for example, be quartz, for example in the form of quartz flour or quartz sand. The silicate may, for example, be talc, mica or wollastonite. The sulfate may, for example, be baryte (heavy spar, barium sulfate). It is also possible to use mixtures of different fillers and/or different fractions of a filler having different sizes. The fillers may take customary forms. More particularly, it is possible to use powders, but also hollow beads (for example of glass or ceramic) or fibers.

More preferably, the inorganic filler is silicon dioxide, especially quartz, more preferably quartz sand.

The fillers used preferably have grain sizes, for example, of 1 μm to 1 cm, especially between 10 μm and 6 mm. The average grain size of the fillers may, for example, be between 10 μm and 3 mm. The grain size and grain size distribution of fillers can be ascertained by sieve analysis or by microscope analysis.

The solid component (C) may also contain one or more additional additives. Examples are auxiliaries and admixtures that are customary in the cement industry, for example plasticizers, setting accelerators, water reducers or deaerators/defoamers.

In the multicomponent composition, the proportion by weight of the solid component (C) is 25-62% by weight, based on the total weight of the multicomponent composition. Preferably, the proportion by weight of the solid component (C) is 30-60% by weight, especially 40-57.5% by weight, preferably 45-55% by weight, based on the total weight of the multicomponent composition.

It is clear from comparative example Ref5 (proportion by weight of component (C) 64.3% by weight) that, in the case of too high a proportion of component (C), gloss, visual appearance, leveling and processibility adopt inadequate values.

In a preferred embodiment, the multicomponent composition contains 5-62% by weight, 5-50% by weight, 5-30% by weight, 8-25% by weight, 12-22.5% by weight, 18-22% by weight, of a hydraulic inorganic binder, preferably cement, based on the total weight of the multicomponent composition.

This is especially advantageous in order to obtain coatings or primer coats, especially floor coatings or floor primer coats. The main difference between coatings and primer coats is in the amount of the composition of the invention applied. The composition of the invention is referred to as primer coats when a relatively small amount of material is applied in order to obtain layer thicknesses up to about 500 μm. Even greater layer thicknesses are generally referred to as coatings, although the transition from primer coats to coating is not sharply delimited. Preferably, a primer coat has a layer thickness of 0.2-0.5 mm. A coating preferably has a layer thickness of 0.8-3.5 mm.

Preferably more than 70% by weight, more than 80% by weight, more than 90% by weight, especially more than 95% by weight, more preferably 100% by weight, of the hydraulic inorganic binder, preferably cement, is in the solid component (C).

In a preferred embodiment, the multicomponent composition contains 0-5% by weight, 0-2% by weight, 0-1% by weight, 0-0.5% by weight, especially 0-0.1% by weight, of a hydraulic inorganic binder, preferably cement, based on the total weight of the multicomponent composition.

This is especially advantageous in order to obtain seals, also called “topcoats”, especially floor seals. Such seals preferably have a layer thickness of 0.1-0.9 mm, especially 0.2-0.5 mm.

The aforementioned hydraulic inorganic binders are inorganic binders that are hardenable with water, even under water. Hydraulic inorganic binders here also include what are called latently hydraulic binders that set with water under the action of additions, for example blast furnace slag.

Examples of suitable hydraulic inorganic binders are hydraulic lime, cement, fly ash, rice husk ash, calcined recycling products from the paper industry, foundry sand and blast furnace slag and mixtures thereof, particular preference being given to cement. It is possible to use all standard types of cement, especially a cement according to European standard EN 197. It is of course also possible to use cement types according to a different cement standard. It is possible to use one cement or a mixture of different cement types.

Preferred cements are portland cements, sulfoaluminate cements and alumina cements, especially portland cement. Mixtures of cements can lead to particularly good properties. Examples are mixtures of at least one portland cement with either at least one sulfoaluminate cement or with at least one alumina cement. The use of white cement is particularly advantageous.

The multicomponent composition comprises 3-15% by weight of water, based on the total weight of the multicomponent composition.

Preferably, the multicomponent composition contains 4-12% by weight, especially 5-10% by weight, preferably 6-9% by weight, of water, based on the total weight of the multicomponent composition.

It is clear from comparative example Ref4 (proportion by weight of water 19.9% by weight) that, in the case of too high a proportion of water, gloss, visual appearance, leveling and processibility adopt inadequate values.

Moreover, example Ex9 (proportion by weight of water 12.1% by weight) shows that, in the case of compositions containing inorganic binders, especially cement, a proportion by weight above 12% by weight leads to a slight deterioration in the values of gloss, leveling and processibility.

Preferably more than 50% by weight, more than 80% by weight, especially more than 90% by weight, more than 95% by weight, of the water is present in the curing component (B).

It may also be advantageous to choose the amount of water in the multicomponent composition preferably such that the weight ratio of water to hydraulic inorganic binder, preferably cement, is in the range from 0.3 to 0.8.

It may also be advantageous for the stoichiometric ratio of epoxy functionality to amine functionality to be 75%-125% (or 0.75-1.25), preferably 80%-120%, especially 90%-110%.

It may also be advantageous for the weight ratio of the solid component (C) to the binder component (A) to be 1.5-2.3, especially 1.6-2.0.

It may also be advantageous for the multicomponent composition, based on the total weight, to contain ≤50% by weight, ≤45% by weight, ≤40% by weight, 15-32% by weight, 20-32% by weight, 25-31% by weight, 26-30% by weight, of organic components OA, where the organic components OA are epoxy resins, reactive diluents, amine compounds PA and compounds VB.

It is clear from the comparison of comparative example Ref1 (without water and without compound VB) with, for example, example Ex1 or Ex2 that, in the inventive examples, the same values can be obtained for gloss, visual appearance, leveling and processibility, but with a significantly lower proportion of organic components OA. In this way, it is possible to achieve a high proportion of environmentally friendly components.

Moreover, it may be advantageous for the weight ratio of organic components OA to the total amount of water to be 2-8, especially 2.5-5, where the organic components OA are epoxy resins, reactive diluents, amine compounds PA and compounds VB.

Further optional additives that may especially be present in the binder component (A) and/or in the curing component (B), but optionally also in one or more other components, are additives that are customarily used in this field, for example stabilizers against heat, light or UV radiation; flame-retardant substances and biocides.

The multicomponent composition may, as well as the three components mentioned, if required, comprise further additional components. An example of such an optional additional component is a pigment component (D).

The pigments may be inorganic or organic pigments. Examples of inorganic pigments are titanium dioxide, carbon black, bismuth pigments, iron oxide pigments, chromium oxides, mixed phase oxide pigments, Prussian blue, ultramarine, cobalt pigments and chromate pigments. Examples of organic pigments are azo pigments and polycyclic pigments such as copper phthalocyanine, quinacridone, diketopyrrolopyrrole, perylene, isoindoline, dioxazine and indanthrone pigments.

The multicomponent composition also preferably contains 0.1% by weight to 10% by weight, preferably 0.5% by weight to 5% by weight, of pigment as colorant, based on the total weight.

In addition, for example, some of the water may be present as a separate component which is only added on mixing of the components prior to use, in order to establish the desired amount of water.

The invention also relates to a method of producing a coating, primer coat or seal, preferably a floor coating, floor primer coat or floor seal, with an above-described multicomponent composition, wherein the method comprises the following method steps:
a) mixing the binder component (A) and the curing component (B),
b) adding the solid component (C) and optionally a hydraulic inorganic binder, and optionally adding water and compound VB if water and compound VB were not already present in the binder component (A) or the curing component (B), to the mixture obtained in step a) while stirring in order to obtain a mixed composition,
c) applying the mixed composition obtained to a substrate,
d) optionally smoothing or deaerating the mixed composition applied and
e) curing the mixed composition applied in order to obtain the coating, primer coat or seal.

The applying of the mixed composition and the curing are advantageously effected, for example, at temperatures in the range from 5 to 40° C.

As explained, the multicomponent composition may also comprise one or more additional components. The manner and sequence of addition of the additional components to the mixture of the composition is as desired, but preference is given to mixing in one or more additional liquid components, if used, in step a). One or more additional solid components, if used, are preferably mixed in in step b).

The substrate may be provided with a primer coat prior to the application of the mixed composition. In addition, it is possible to apply a top layer as sealing layer to the mixed composition applied.

The substrate may be any desired material. It is preferably a floor covering, for example of concrete, mortar or screed, which may optionally have a coating, for example a scratchcoat or a primer coat and/or another customary coating.

The mixing of the multicomponent composition begins the curing reaction. The epoxy groups of the epoxy resin and optionally of the reactive diluent react with the reactive NH hydrogens to form the organic binder matrix, while any hydraulic inorganic binder present together with the water forms the inorganic binder matrix by hydration reactions, which ultimately results in curing of the composition. Thus, the present invention also relates to a cured composition or coating.

The invention therefore also relates to a coating, primer coat or seal, especially floor coating, floor primer coat or floor seal, obtainable by the process described above.

The invention relates to use of an above-described multicomponent composition as coating, primer coat or seal, especially floor coating, floor primer coat or floor seal.

### EXAMPLES

The following commercial products are used:

| | |
|---|---|
| Component A | EEW 240 g/eq, SikaFloor 253 component A, |
| | Sika Schweiz AG, 65% by weight of epoxy resins, |
| | 10% by weight of reactive diluents. |
| Additives | dispersants and defoamers |
| D.E.H. 804 | aqueous amine curing agent, polyamine- |
| | polyepoxide adduct, solids content 70% by weight, |
| | Dow Chemical Company |
| EPILINK 701 | EPILINK 701, polyamine-polyepoxide adduct, |
| | AirProducts |
| IPDA | Vestamin ® IPD, 3-aminomethyl-3,5,5- |
| | trimethylcyclohexylamine, Evonik |
| Cement | CEM I 52.5R white cement, Valderrivas |
| Quartz sand | 0.06-0.3 mm |

Three-component compositions were formulated according to tables 1a and 1b below. Tables 2a and 2b list properties of the compositions Ex1-Ex9 (inventive compositions) and Ref1-Ref11 (comparative examples). Composition Ref11 is a composition as described in WO2009150212 on page 42 as example 30.

### Preparation of “ex. 10”

The raw material “ex. 10” comprising the compound VB was prepared as described in WO2009150212 on pages 39 to 40 for preparation of example 10, except that less water was used for the preparation. The water content of the final product was 20% by weight, rather than 50% by weight as shown in table 2 on page 40 in WO2009150212. The “ex. 10” raw material used in the present document therefore contains 20% by weight of water, 32% by weight of the compound VB, 36% by weight of polyamine-polyepoxide adduct AD and 12% by weight of polyamine A4 (IPDA).

### Preparation of Component B

To an initial charge of water in a suitable vessel are added the further raw materials with stirring by dissolver.

### Preparation of the Mixed Compositions

Components A and B are mixed in the mixing ratio specified with a paddle stirrer and, after good mixing (about 1-2 minutes), component C is added continuously and mixed for about a further 3 minutes.

The mixed compositions Ex1-Ex9 and Ref1-Ref11 were tested as follows:

### Measurement of Gloss

Gloss was measured to EN ISO 2813 at an angle of incidence of 85°. All samples had a film thickness of 2 mm after curing at 23° C. and 50% relative air humidity for 24 h. The results of the gloss measurements are shown in table 2a.

### Workability

Workability is determined by the user during application. The crucial factor here is the resistance with which the coating can be distributed. The aim is to be able to apply a 2 mm-thick layer with proportionate expenditure of force and in appropriate time with a toothed spatula. The reference is the self-leveling coating systems available on the market and the application properties thereof.

### Leveling

Leveling is ascertained by visual assessment of a self-leveling coating worked with a toothed spatula. The coating is applied homogeneously as a layer of thickness 2 mm at 23° C. Subsequently, the toothed spatula is used to pile the material up to a thickness of 10 mm at one point. After curing, any remaining traces of this experiment are assessed. The results of the leveling measurements are shown in table 2a.

### Visual Appearance

The visual appearance of the self-leveling coating applied by methods described above is assessed (toothed spatula, layer of thickness 2 mm, 23° C.). Important aspects are how uniformly the surface has cured. Disadvantageous surface defects that are taken into account are spots, graininess of the surface, remaining waves and the resulting disturbed appearance of the surface, and pinholes. Pinholes refer to small holes that remain in the surface.

The weight ratio of amine compound PA to compound VB is shown as PA/VB. The proportion of the organic components OA, based on the total weight of the multicomponent composition, is reported in % by weight as “OA content”. The amount of water or cement present is reported as % by weight, based on the total weight of the multicomponent composition.

The weight ratio of water to cement is shown as W/C.

The epoxy functionality and the amine functionality of the multicomponent composition are listed respectively as EP eq and as NH eq in [g/eq]. The stoichiometric ratio of epoxy functionality to amine functionality is shown in % as “Sto. rt.”. The weight ratio of organic components OA to the total amount of water is reported as “OA/W”. The weight ratio of the solid component (C) to the binder component (A) is reported as C/A.

TABLE 1a

| Raw | | | | | | | | | | |
|---|---|---|---|---|---|---|---|---|---|---|
| material | Ex1 | Ex2 | Ex3 | Ex4 | Ex5 | Ex6 | Ex7 | Ex8 | Ex9 | Ref1 |
| A:B:C | 63:37:120 | 74:26:120 | 69:31:120 | 68:32:120 | 68:32:120 | 71:29:120 | 68:32:120 | 69:31:120 | 60:40:120 | 84:16:120 |
| Component A | 63 | 74 | 69 | 68 | 68 | 71 | 68 | 69 | 60 | 84 |
| % by wt. of A | 28.6 | 33.6 | 31.4 | 30.9 | 30.9 | 32.3 | 30.9 | 31.4 | 27.3 | 38.2 |
| Component B | | | | | | | | | | |
| IPDA | 9.6 | 11.3 | 10.8 | 9.2 | 10.4 | 10.8 | 9.2 | 10.8 | 9.2 | 14.3 |
| Ex. 10 | 3.9 | 4.6 | 2.2 | 7.5 | 4.3 | 4.4 | 7.5 | 2.2 | 3.6 | — |
| D.E.H. ® 804 | | | | | | | | | | |
| EPILINK | | | | | | | | | | |
| 701 ® | | | | | | | | | | |
| Water | 22.3 | 8.7 | 16.7 | 14.2 | 16.1 | 12.5 | 14.2 | 16.7 | 26 | — |
| Additives | 1.2 | 1.4 | 1.3 | 1.1 | 1.2 | 1.3 | 1.1 | 1.3 | 1.2 | 1.7 |
| Total B | 37 | 26 | 31 | 32 | 32 | 29 | 32 | 31 | 40 | 16 |
| % by wt. of B | 16.8 | 11.8 | 14.1 | 14.5 | 14.5 | 13.2 | 14.5 | 14.1 | 18.2 | 7.3 |
| Component C | | | | | | | | | | |
| Quartz sand | 120 | 120 | 120 | 120 | 75.6 | 75.6 | 75.6 | 75.6 | 75.6 | 120 |
| Cement | | | | | 44.4 | 44.4 | 44.4 | 44.4 | 44.4 | |
| Total C | 120 | 120 | 120 | 120 | 120 | 120 | 120 | 120 | 120 | 120 |
| % by wt. of C | 54.5 | 54.5 | 54.5 | 54.5 | 54.5 | 54.5 | 54.5 | 54.5 | 54.5 | 54.5 |
| Total pts. by wt. | 220 | 220 | 220 | 220 | 220 | 220 | 220 | 220 | 220 | 220 |

TABLE 1b

| Raw material | Ref2 | Ref3 | Ref4 | Ref5 | Ref7 | Ref8 | Ref9 | Ref10 | Ref11 |
|---|---|---|---|---|---|---|---|---|---|
| A:B:C | 68:32:120 | 84:16:120 | 46:54:120 | 68:32:180 | 60:40:120 | 59:41:120 | 59:41:120 | 59:41:120 | |
| Component A | 68 | 84 | 46 | 68 | 60 | 59 | 59 | 59 | 10* |
| % by wt. of A | 30.9 | 38.2 | 20.9 | 24.3 | 27.3 | 26.8 | 26.8 | 26.8 | 5.4 |
| Component B | | | | | | | | | |
| I PDA | 12 | 14.3 | 7 | 10.4 | 9.2 | 9 | 9.9 | 9 | |
| Ex. 10 | — | — | 2.9 | 4.3 | | | | | 7.2 |
| D.E.H. ® 804 | | | | | 3.6 | 5.3 | | | |
| EPILINK | | | | | | | 1.9 | 5.3 | |
| 701 ® | | | | | | | | | |
| Water | 18.6 | — | 43.3 | 16.1 | 26 | 25.5 | 27.9 | 25.5 | 17.6 |
| Additives | 1.4 | 1.7 | 0.8 | 1.2 | 1.2 | 1.2 | 1.3 | 1.2 | 0.2 |
| Total B | 32 | 16 | 54 | 32 | 40 | 41 | 41 | 41 | 25 |
| % by wt. of B | 14.5 | 7.3 | 24.5 | 11.4 | 18.2 | 18.6 | 18.6 | 18.6 | 13.5 |
| Component C | | | | | | | | | |
| Quartz sand | 120 | 75.6 | 75.6 | 113.4 | 75.6 | 75.6 | 75.6 | 75.6 | 94.5 |
| Cement | | 44.4 | 44.4 | 66.6 | 44.4 | 44.4 | 44.4 | 44.4 | 55.5 |
| Total C | 120 | 120 | 120 | 180 | 120 | 120 | 120 | 120 | 150 |
| % by wt. of C | 54.5 | 54.5 | 54.5 | 64.3 | 54.5 | 54.5 | 54.5 | 54.5 | 81.1 |
| Total pts. by wt. | 220 | 220 | 220 | 280 | 220 | 220 | 220 | 220 | 185 |

*component A of Ref11 as described as example 30 on page 42 in W02009150212

TABLE 2a

| | Visual | Work- | | | | | OA content |
|---|---|---|---|---|---|---|---|
| | appearance | ability | Leveling | Gloss | Comments | PA/VB | [% by wt.] |
| Ex1 | ++ | ++ | ++ | 97 | | 8.7 | 26 |
| Ex2 | ++ | ++ | ++ | 101 | | 8.7 | 31 |
| Ex3 | ++ | ++ | ++ | 91 | | 15.9 | 28 |
| Ex4 | + | + | + | 101 | Many pinholes | 5.0 | 29 |
| Ex5 | + | +++ | ++ | 96 | | 8.7 | 29 |
| Ex6 | + | +++ | ++ | 102 | A few pinholes | 8.7 | 30 |
| Ex7 | + | ++ | + | 100 | Many pinholes | 5.0 | 29 |
| Ex8 | − | ++ | ++ | 103 | | 15.9 | 28 |
| Ex9 | + | + | + | 87 | A few pinholes | 9.1 | 25 |
| Ref1 | ++ | ++ | ++ | 104 | | — | 34 |
| Ref2 | − | ++ | −− | 90 | | — | 28 |
| Ref3 | −− | +++ | −− | 106 | | — | 34 |
| Ref4 | −− | − | −− | n.m. | | 8.7 | 19 |
| Ref5 | − | − | − | 78 | | 8.7 | 22 |
| Ref7 | − | ++ | − | 24 | Grainy surface, sand not | — | 25 |
| | | | | | sunk in. | | |
| Ref8 | − | ++ | − | 37 | Grainy surface, sand not | — | 25 |
| | | | | | sunk in. | | |
| Ref9 | − | ++ | − | 37 | Grainy surface, sand not | — | 24 |
| | | | | | sunk in. | | |
| Ref10 | − | ++ | − | 31 | Grainy surface, sand not | — | 25 |
| | | | | | sunk in. | | |
| Ref11 | −− | ++ | + | <10 | | 1.4 | |

n.m. = not measurable

TABLE 2b

| | Cement | Water | | EP eq | NH eq | Sto. rt. | | |
|---|---|---|---|---|---|---|---|---|
| | [% by wt.] | [% by wt.] | W/C | [g/eq] | [g/eq] | [%] | C/A | OA/W |
| Ex1 | | 10.5 | | 837.9 | 876 | 95.7 | 1.9 | 2.5 |
| Ex2 | | 4.4 | | 713.4 | 746.6 | 95.6 | 1.6 | 7.1 |
| Ex3 | | 7.8 | | 765.1 | 823.5 | 92.9 | 1.7 | 3.6 |
| Ex4 | | 7.2 | | 776.3 | 838.3 | 92.6 | 1.8 | 4.1 |
| Ex5 | 20.2 | 7.7 | 0.38 | 776.3 | 812.6 | 95.5 | 1.8 | 3.8 |
| Ex6 | 20.2 | 6.1 | 0.30 | 743.5 | 784.6 | 94.8 | 1.7 | 4.9 |
| Ex7 | 20.2 | 7.2 | 0.35 | 776.3 | 838.3 | 92.6 | 1.8 | 4.1 |
| Ex8 | 20.2 | 7.8 | | 765.1 | 823.5 | 92.9 | 1.7 | 3.6 |
| Ex9 | 20.2 | 12.1 | 0.60 | 879.8 | 923.4 | 95.3 | 2.0 | 2.1 |
| Ref1 | | | | 628.5 | 655.1 | 95.9 | 1.4 | |
| Ref2 | | 8.5 | | 776.3 | 781.3 | 99.4 | 1.8 | 3.3 |
| Ref3 | 20.2 | | | 628.5 | 655.1 | 95.9 | 1.4 | |
| Ref4 | 20.2 | 19.9 | 0.99 | 1′147.60 | 1′202.20 | 95.5 | 2.6 | 1.0 |
| Ref5 | 23.8 | 6.1 | 0.25 | 988.1 | 1′034.20 | 95.5 | 2.6 | 3.6 |
| Ref7 | 20.2 | 12.4 | 0.61 | 879.8 | 947.5 | 92.9 | 2.0 | 2.0 |
| Ref8 | 20.2 | 12.4 | 0.62 | 894.8 | 933.1 | 95.9 | 2.0 | 2.0 |
| Ref9 | 20.2 | 13.1 | 0.65 | 894.8 | 924.1 | 96.8 | 2.0 | 1.8 |
| Ref10 | 20.2 | 12.7 | 0.63 | 894.8 | 959 | 93.3 | 2.0 | 2.0 |
| Ref11 | 30.0 | 11.5 | 0.38 | | | | 15 | |

1. A multicomponent composition comprising
A) a binder component (A) comprising at least one epoxy resin,
B) a curing component (B) comprising at least one amine compound PA, and
C) a solid component (C) comprising at least one inorganic filler, wherein
the multicomponent composition contains 3-15% by weight of water, based on the total weight of the multicomponent composition,
and in that the multicomponent composition further comprises a compound VB of the formula (I) or (II) 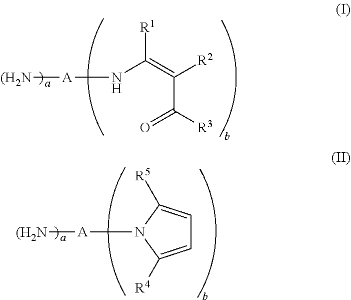
where
either
R¹ and R³ are each independently an alkyl, cycloalkyl, aryl or arylalkyl group which has 1 to 12 carbon atoms and optionally has ether groups or halogen atoms, and
R² is a hydrogen atom or an alkyl, cycloalkyl, aryl or arylalkyl group having 1 to 12 carbon atoms,
or
R² and R¹ together are a divalent hydrocarbyl radical which is part of an optionally substituted carbocyclic ring having 5 to 8 carbon atoms and R³ is an alkyl, cycloalkyl, aryl or arylalkyl group which has 1 to 12 carbon atoms and optionally has ether groups or halogen atoms;
or
R² and R³ together are a divalent hydrocarbyl radical which is part of an optionally substituted carbocyclic ring having 5 to 8 carbon atoms and R¹ is an alkyl, cycloalkyl, aryl or arylalkyl group which has 1 to 12 carbon atoms and optionally has ether groups or halogen atoms;
R⁴ and R⁵ are each independently an alkyl, cycloalkyl, aryl or arylalkyl group which has 1 to 12 carbon atoms and optionally has ether groups or halogen atoms;
A is an (a+b)-valent radical of a polyamine-polyepoxide adduct after removal of (a+b) primary amino groups;
a is an integer from 0 to 4; and
b is an integer from 1 to 4;
with the provisos that the sum total of a and b is an integer from 1 to 4, and that the parent polyepoxide of the polyamine-polyepoxide adduct is a polyepoxide E, especially a diepoxide E1, and has an epoxy equivalent weight (EEW) of 65 to 500 g/eq,
and where the weight ratio of amine compound PA to compound VB is 4-20,
and where the proportion by weight of the solid component (C) is 25-62% by weight, based on the total weight of the multicomponent composition.

2. The multicomponent composition as claimed in claim 1, wherein the at least one amine compound PA is selected from the group consisting of polyamine A4, polyaminoamide, polyamine-polyepoxide adduct AD and polyaminoamide-polyepoxide adduct or a mixture of at least two of these compounds.

3. The multicomponent composition as claimed in claim 1, wherein the at least one amine compound PA is a polyamine A4 or a mixture of polyamine A4 and polyamine-polyepoxide adduct AD,
and the polyamine A4 is selected from the group consisting of isophoronediamine (IPDA), bis(4-aminocyclohexyl)methane (H12-MDA), bis(4-amino-3-methylcyclohexyl)methane, 2,2,4- and 2,4,4-trimethylhexamethylenediamine (TMD), xylylene-1,3-diamine (meta-xylylenediamine or MXDA) and 2-butyl-2-ethylpentane-1,5-diamine (C11 neodiamine), and the polyamine-polyepoxide adduct AD is an adduct of at least one polyamine A3 having at least two amino groups in the form of primary or secondary amino groups and at least one polyepoxide E having an epoxy equivalent weight (EEW) of 65 to 500 g/eq, where the adduct has terminal primary and/or secondary amino groups, and where the polyamine A3 is selected from the group consisting of firstly polyoxyalkylenediamines having a molecular weight of not more than 1000 g/mol, and secondly isophoronediamine (IPDA), 2,2,4- and 2,4,4-trimethylhexamethylenediamine (TMD), xylylene-1,3-diamine (meta-xylylenediamine or MXDA), 2-butyl-2-ethylpentane-1,5-diamine (C11 neodiamine), N-ethylpropane-1,3-diamine and N-cyclohexylpropane-1,3-diamine.

4. The multicomponent composition as claimed in claim 2, wherein the weight ratio of polyamine A4 to polyamine-polyepoxide adduct AD is 5-50.

5. The multicomponent composition as claimed in claim 1, wherein the multicomponent composition contains 4-12% by weight, of water, based on the total weight of the multicomponent composition.

6. The multicomponent composition as claimed in claim 1, wherein the weight ratio of amine compound PA to compound VB is 6-16.

7. The multicomponent composition as claimed in claim 1, wherein the multicomponent composition, based on the total weight of the multicomponent composition, contains 25-40% by weight, of binder component (A).

8. The multicomponent composition as claimed in claim 1, wherein the proportion by weight of the solid component is 30-60% by weight, based on the total weight of the multicomponent composition.

9. The multicomponent composition as claimed in claim 1, wherein the stoichiometric ratio of epoxy functionality to amine functionality is 80%-120%.

10. The multicomponent composition as claimed in claim 1, wherein the weight ratio of the solid component (C) to the binder component (A) is 1.5-2.3.

11. The multicomponent composition as claimed in claim 1, wherein the multicomponent composition contains 5-62% by weight, of a hydraulic inorganic binder, based on the total weight of the multicomponent composition.

12. The multicomponent composition as claimed in claim 1, wherein the multicomponent composition contains 0-5% by weight, of a hydraulic inorganic binder, based on the total weight of the multicomponent composition.

13. A method of producing a coating, primer coat or seal, floor primer coat or floor seal, with a multicomponent composition as claimed in claim 1, wherein the method comprises the following method steps:
a) mixing the binder component (A) and the curing component (B),
b) adding the solid component (C) and optionally a hydraulic inorganic binder, and optionally adding water and compound VB if water and compound VB were not already present in the binder component (A) or the curing component (B), to the mixture obtained in step a) while stirring in order to obtain a mixed composition,
c) applying the mixed composition obtained to a substrate,
d) optionally smoothing or deaerating the mixed composition applied and
e) curing the mixed composition applied in order to obtain the coating, primer coat or seal.

14. A coating, primer coat or seal, floor primer coat or floor seal, obtainable by a method as claimed in claim 13.

15. A method of using a multicomponent composition as claimed in claim 1, the method comprising coating, priming, or sealing a floor with the multicomponent composition.
